(19) United States
(12) Patent Application Publication
(10) Pub. No.: US 2014/0119422 A1
(43) Pub. Date: May 1, 2014

(54) MULTI-STAGE EQUALIZER

(71) Applicant: HON HAI PRECISION INDUSTRY CO., LTD., New Taipei (TW)

(72) Inventors: EN-SHUO CHANG, New Taipei (TW); PO-CHUAN HSIEH, New Taipei (TW)

(73) Assignee: HON HAI PRECISION INDUSTRY CO., LTD., New Taipei (TW)

(21) Appl. No.: 14/067,918

(22) Filed: Oct. 30, 2013

(30) Foreign Application Priority Data
Oct. 31, 2012 (TW) 101140329

(51) Int. Cl. H04L 27/01

(52) U.S. Cl. CPC H04L 27/01
USPC 375/229

(57) ABSTRACT

An equalizer includes a multi-layer printed circuit board, an equalizing module, a first ground via, and a second ground via. The equalizing module includes two inputs, first and second signal vias, first and second resistors, two outputs, first and second microstrip lines. The first microstrip line extends from a side of a pad, which is connected to the first signal via and a bottom layer of the printed circuit board. The first microstrip line is bent and connected to a pad, which is connected to a first terminal of the second resistor. The second microstrip line extends from a side of a pad, which is connected to the second signal via and a bottom layer of the printed circuit board. The second microstrip line is bent and connected to a pad, which is connected to a second terminal of the second resistor.

### BACKGROUND

1. Technical Field

The present disclosure relates to an equalizer.

2. Description of Related Art

High frequency signals, such as digital signals, are prone to attenuate during transmission. The attenuation raises a transmission error rate of high frequency signals. It is essential to compensate the frequency signals before the transmission through an equalizer. Typically, the equalizer can only compensate high frequency signals for one stage, but has a small effect when there is need for multi-stage compensation. FIG. 6 is a simulation diagram of a serial attached small computer system interface (SAS) signal transmitted without an equalizer. Because of channel attenuation and inter symbol interference effect, integrity of the SAS signal transmitted without the equalizer cannot meet requirements.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is an isometric view of an embodiment of an equalizer of the present disclosure.

FIG. 2 is an inverted view of FIG. 1.

FIG. 3 is an isometric view of an equalizing module of the equalizer of FIG. 1.

FIG. 4 is a curve diagram of time domain waveforms of a signal transmitted with or without the equalizer of FIG. 1.

FIG. 5 is a simulation diagram of a serial attached small computer system interface (SAS) signal transmitted with the equalizer of FIG. 1.

FIG. 6 is a simulation diagram of the SAS signal transmitted without the equalizer of FIG. 1.

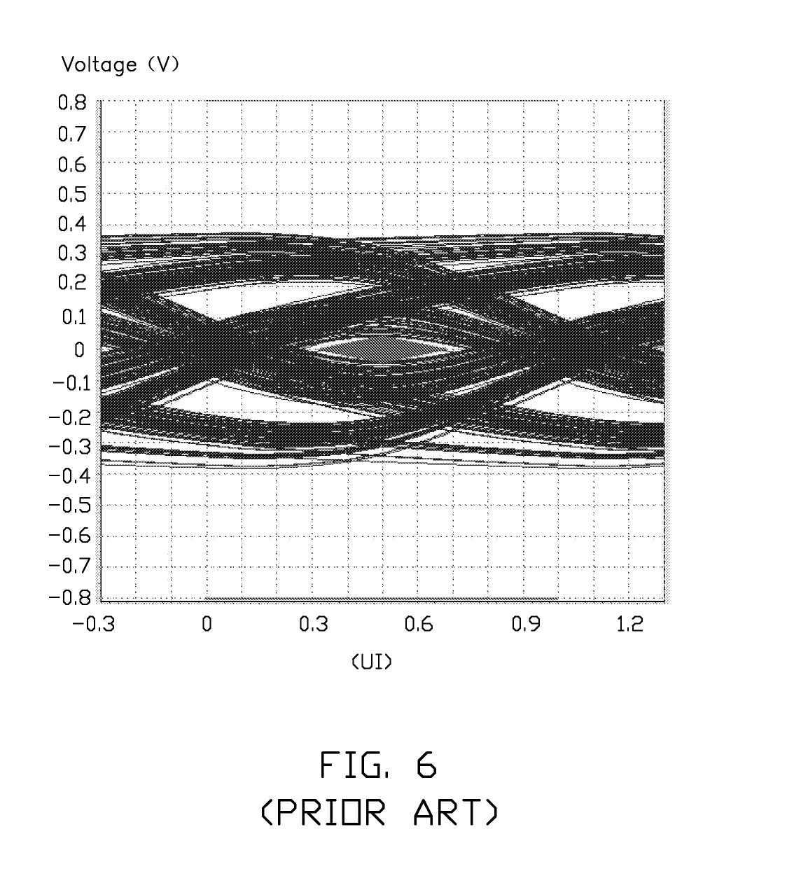

### DETAILED DESCRIPTION

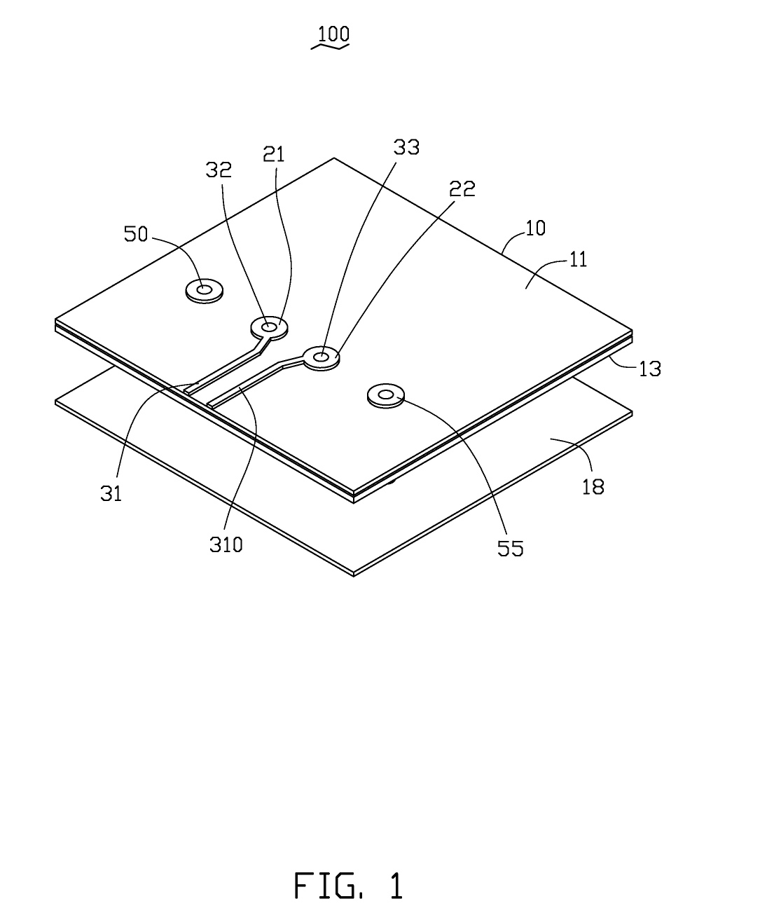

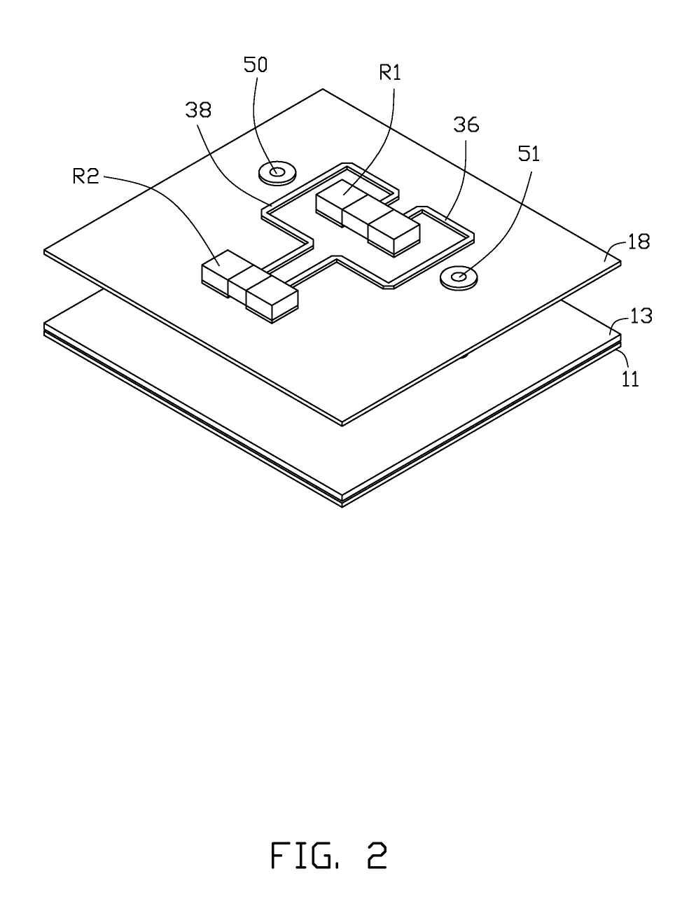

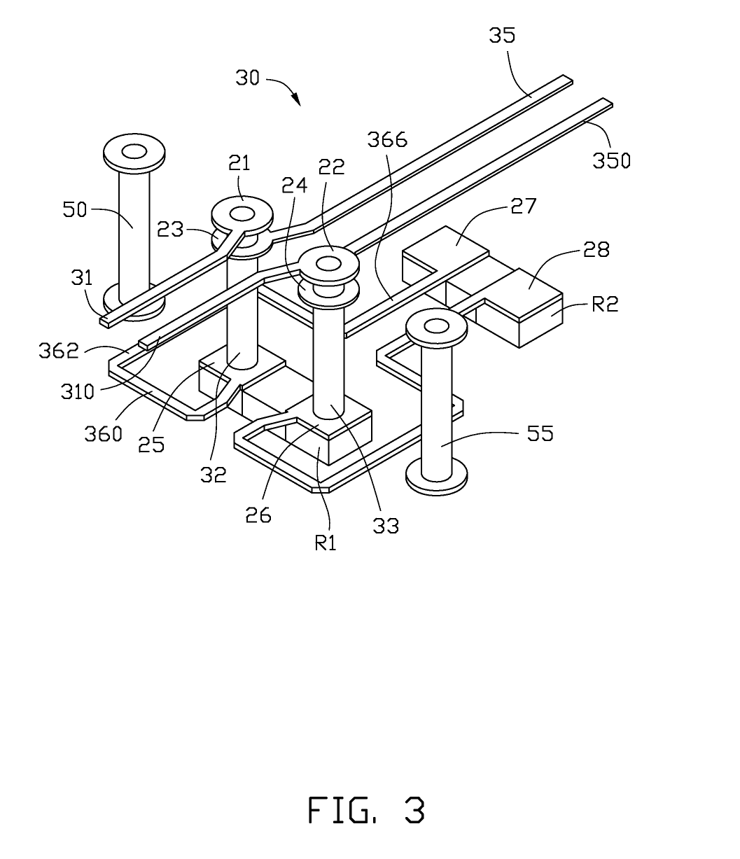

FIGS. 1 to 3 show an embodiment of an equalizer 100 of the present disclosure.

The equalizer 100 includes a multi-layer printed circuit board 10, an equalizing module 30, a first ground via 50, and a second ground via 55.

The multi-layer printed circuit board 10 is used to receive an original signal. The original signal is compensated in the equalizing module 30.

In this embodiment, the multi-layer printed circuit board 10 includes eight layers, and three of which are shown in FIG. 1. In other embodiments, the multi-layer printed circuit board 10 can include 2,3,4, n layers, where n is an integer.

The equalizing module 30 includes a first input 31, a second input 310, a first signal via 32, a second signal via 33, resistors R1 and R2, a first output 35, a second output 350, and two microstrip lines 36 and 38.

The first signal via 32 and the second signal via 33 both extend through the eight layers of the multi-layer printed circuit board 10. The first signal via 32 is electrically connected to a top signal layer 11, a bottom signal layer 18, and a mid signal layer 13 between the top signal layer 11 and the bottom signal layer 18, bottom signal layer through bonding pads 21, 25 and 23, respectively. The second signal via 33 is electrically connected to the top signal layer 11, the mid signal layer 13, and the bottom signal layer 18, through bonding pads 22, 24, and 26, respectively.

The first input 31 and the second input 310 are connected to the bonding pads 21 and 22, respectively. In this embodiment, the first input 31 and the second input 310 are strip-shaped. The first input 31 and the second input 310 are set on the top signal layer 11 to receive the original signal.

The first output 35 and the second output 350 are connected to the bonding pads 23 and 24, respectively. In this embodiment the first output 35 and the second output 350 are strip-shaped. The first output 35 and the second output 350 are set on the mid signal layer 13, to output an equalized signal about the original signal.

The bonding pads 25 and 26 are electrically connected to two ends of the resistor R1, respectively. Two bonding pads 27 and 28 are set on the mid signal layer 13 and at a side of the bonding pads 25 and 26. A beeline between the bonding pads 25 and 27 is parallel to a beeline between the bonding pads 26 and 28. The bonding pads 27 and 28 are electrically connected to two ends of the resistor R2, respectively.

The microstrip lines 36 and 38 are symmetrical in structure. Each of the microstrip lines 36 and 38 includes a first part 360, a second part 362, and a third part 366. The first part 360 of the microstrip 36 extends from a side of the bonding pad 25 opposite to the bonding pad 27 and extends away from the bonding pad 27. The third part 366 of the microstrip 36 extends from a side of the bonding pad 27 facing the bonding pad 25 and extends toward the bonding pad 25. The second part 362 of the microstrip 36 is U-shaped. A first end of the second part 362 of the microstrip 36 is connected to an end of the first part 360 opposite to the bonding pad 25. A second end of the second part 362 of the microstrip 36 is connected to an end of the third part 366 opposite to the bonding pad 27. The first part 360 of the microstrip 38 extends from a side of the bonding pad 26 opposite to the bonding pad 28 and extends away from the bonding pad 28. The third part 366 of the microstrip 38 extends from a side of the bonding pad 28 facing the bonding pad 26 and extends toward the bonding pad 26. The second part 362 of the microstrip 38 is U-shaped. A first end of the second part 362 of the microstrip 38 is connected to an end of the first part 360 opposite to the bonding pad 26. A second end of the second part 362 of the microstrip 38 is connected to an end of the third part 366 opposite to the bonding pad 28. The microstrips 36 and 38, and the resistors R1 and R2 are set on the bottom signal layer 18.

The first ground via 50 and the second ground via 55 are in alignment with the first signal via 32 and the second signal via 33. The first and second signal vias 32 and 33 are located between the first ground via 50 and the second ground via 55. The first signal via 32 is adjacent to the first ground via 50, and the second signal via 33 is adjacent to the second ground via 55. The first ground via 50 and the second ground via 55 are electrically connected to ground layers of the multi-layer printed circuit board 10 to form current return paths for the signal flowing through the first signal via 32 and the second signal via 33.

The second part 362 of the microstrip 36 is located between the first ground via 50 and the resistor R1. The second part 362 of the microstrip 38 is located between the second ground via 55 and the resistor R1.

When a signal received by the first input 31 and the second input 310 is transmitted through the first signal via 32 and the second signal via 33, a first part of the signal is output from the first output 35 and the second output 350, a second part of the signal is transmitted to the resistor R1. The second part of the signal is partly reflected by the resistor R1 and returns to the first output 35 and the second output 350, which is a first stage of compensation. A remaining part of the second part of the signal is transmitted from the resistor R1 to the resistor R2 and is reflected by the resistor R2. The remaining part of the second part of the signal is reflected between the resistor R1 and R2. The remaining part of the second part of the signal partly returns to the first output 35 and the second output 350, which is a second stage of compensation. An equilibrium effect of the equalizer 100 depends on resistance of the resistor R1 and R2 and a length of the microstrip lines 36 and 38.

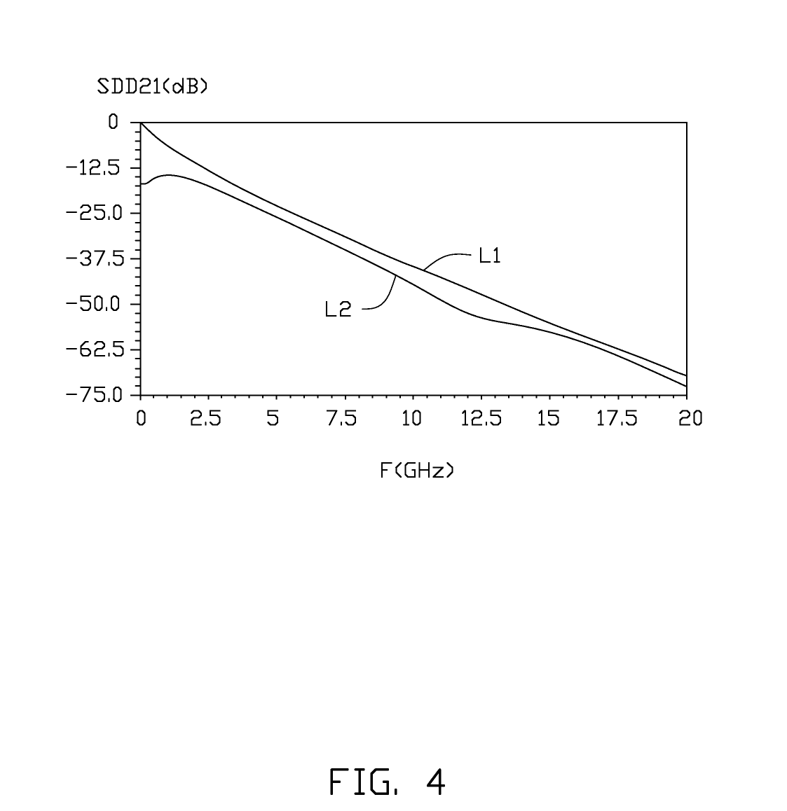

FIG. 4 shows that line L1 is a waveform of a signal transmitted without the equalizer 100. Line L2 is a waveform of the signal transmitted with the equalizer 100. In the illustrated embodiment, the resistance of R1 is 100 ohms and the resistance of R2 is 10 ohms

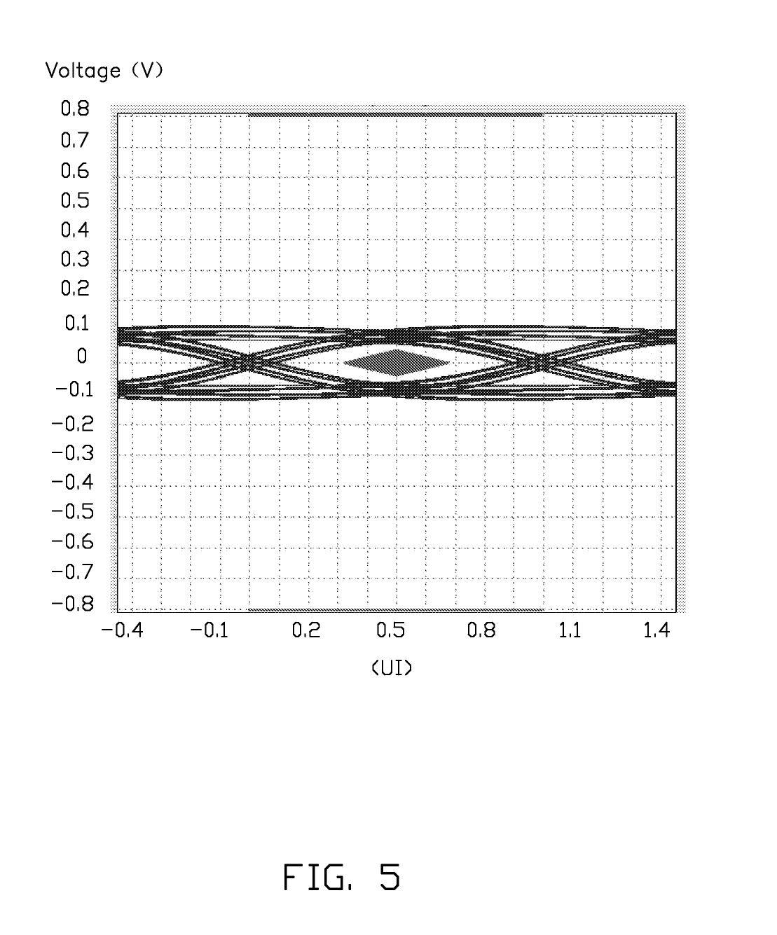

FIG. 5 is a simulation diagram of a serial attached small computer system interface (SAS) signal transmitted with the equalizer 100. When the SAS signal is transmitted with the equalizer 100, because of the first and second stage of compensation, integrity of the SAS signal can meet requirements.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An equalizer, comprising:
a multi-layer printed circuit board comprising a first signal layer, a second signal layer, and a third signal layer;
first and second ground vias;
an equalizing module set on the printed circuit board, the equalizing module comprising first and second inputs both set on the first signal layer, first and second signal vias, first and second resistors both set on the second signal layer, first and second outputs both set on the third signal layer, first and second microstrip lines both set on the second signal layer, and first to eighth bonding pads, wherein the first signal via and the second signal via both extend through the first to third layers of the printed circuit board;
wherein the first signal via is electrically connected to the first signal layer, the third signal layer, and the second signal layer through the first to third bonding pads respectively, the second signal via is electrically connected to the first signal layer, the third signal layer, and the second signal layer through the fourth to sixth bonding pads respectively;
wherein the first input is connected to the first bonding pad, the second input is connected to the fourth bonding pad, the first output is connected to the third bonding pad, the second output is connected to the sixth bonding pad, two ends of the first resistor are connected to the second bonding pad and the fifth bonding pad respectively, the seventh bonding pad and the eighth bonding pad are set on the second signal layer and at a side of the second bonding pad and the fifth bonding pad, a beeline between the seventh bonding pad and the second bonding pad is parallel to a beeline between the eighth bonding pad and the fifth bonding pad, two ends of the second resistor are connected to the seventh bonding pad and the eighth bonding pad respectively, the first microstrip line is connected between the second bonding pad and the seventh bonding pad after, the second microstrip is connected between the fifth line and the eighth bonding pad, the first ground via is set on a side of the first signal via opposite to the second signal via, the second ground via is set on a side of the second signal via opposite to the first signal via.

2. The equalizer of claim 1, wherein the first microstrip line comprises a first part, a second part, and a third part, the first part extends from a side of the second bonding pad opposite to the seventh bonding pad and extends away from the seventh bonding pad, the third part extends from a side of the seventh bonding pad facing the second bonding pad and extends toward the second bonding pad, the second part is U-shaped, a first end of the second part is connected to an end of the first part opposite to the second bonding pad, a second end of the second part is connected to an end of the third part opposite to the seventh bonding pad.

3. The equalizer of claim 1, wherein the second microstrip line comprises a first part, a second part, and a third part, the first part extends from a side of the fifth bonding pad opposite to the eighth bonding pad and extends away from the eighth bonding pad, the third part extends from a side of the eighth bonding pad facing the fifth bonding pad and extends toward the fifth bonding pad, the second part is U-shaped, a first end of the second part is connected to an end of the first part opposite to the fifth bonding pad, a second end of the second part is connected to an end of the third part opposite to the eighth bonding pad.

4. The equalizer of claim 1, wherein the first and second inputs are strip-shaped.

5. The equalizer of claim 1, wherein the first and second outputs are strip-shaped.

6. The equalizer of claim 1, wherein the first ground via, the second ground via, the first signal via, and the second signal via are in alignment with one another.

7. The equalizer of claim 1, wherein the third signal layer is located between the first signal layer and the second signal layer.
